(19) United States
(12) Patent Application Publication
(10) Pub. No.: US 2021/0004635 A1
(43) Pub. Date: Jan. 7, 2021

(54) METHOD AND SYSTEM FOR IDENTIFYING A PEDESTRIAN

(71) Applicant: NATIONAL CHIAO TUNG UNIVERSITY, Hsinchu (TW)

(72) Inventors: Jiun-In GUO, Hsinchu (TW); Tai-En WU, Hsinchu (TW)

(73) Assignee: NATIONAL CHIAO TUNG UNIVERSITY, Hsinchu (TW)

(21) Appl. No.: 16/893,708

(22) Filed: Jun. 5, 2020

(30) Foreign Application Priority Data
Jul. 4, 2019 (TW) 108123512

(51) Int. Cl. G06K 9/62; G06K 9/32

(52) U.S. Cl. CPC G06K 9/6204; G06K 9/3233; G06K 9/6232

(57) ABSTRACT

A method and system for identifying a pedestrian is disclosed. The method comprises: capturing a original image and detecting a pedestrian in the original image so as to obtain a 2D pedestrian feature image; obtaining a 3D information and identifying the 3D information so as to obtain a 3D pedestrian feature map; projecting the 3D pedestrian feature map to a 2D pedestrian feature plane image; and matching the 2D pedestrian feature imager and the 2D pedestrian feature plane image to obtain a matched image; wherein the original image and the 3D information are obtained simultaneously.

### BACKGROUND

### Technical Field

The present invention relates to a method and system for identifying a pedestrian, and in particular, the present invention relates to method and system for identifying a pedestrian of combining Lidar and dual sensors of RGB cameras.

### Related Art

With the progress of science and technology, the application of pedestrian detection system is becoming more and more popular, however, the current pedestrian detection system in the process of detection often by the shooting scene of various variables and interference to make the detection results of the accuracy decreased. For example, in an environment with uneven lighting, some parts of pedestrians are too bright or too dark, or the pedestrian's drive is partially hidden, and existing pedestrian detection systems often cannot accurately determine whether a pedestrian exists in the scene.

The existing technology improves the above problem by combining the camera with a depth sensor with Lidar, and however, most of the existing technologies use a single image sensor to perform the detection. When the ambient light is dim and pedestrians overlap, pedestrians in the image are not easy to be identified, and the detection rate is low. Or, only the depth sensor is used for detection, but when two objects are connected, it cannot be divided according to the result of the depth sensor detection, which will result in missed judgment.

In addition, in the prior art of pedestrians with existing depth sensors and camera sensors, most of them use Lidar detection points to segment objects firstly and project them into the image to create a region of interest, and identify the objects by the image recognition technology. Or the objects can be identified in the image firstly, and collects the 3D detection points in the area of interest of the candidate pedestrian, and then use the 3D classifier to perform the identification, so when the two objects are connected, the connected objects cannot be divided according to the detection result of the depth sensor, and there will be missed judgments. In addition, in the conventional technology, 3D detection point are directly projected onto a 2D gird map, and objects of different heights at the same location are ignored. The method cannot properly separate obstacle in the environment.

### SUMMARY

One object of the present invention is to provide a method and system for identifying a pedestrian which has a multilayer grid map, and a multilayer grid map is used to create a 2D grid map exclusively for Lidar lasers. The N-layer grid map records the heights of points detected by different heights or different lasers, and retains height information to distinguish objects at different heights. The multilayer grid map has the same number of layers as the laser root number. Comparing with a 3D grid map, a lot of space wasted problems with no detection points at different heights have been removed.

Another object of the present invention is to provide a method and system for identifying a pedestrian, which is different from the conventional method of detecting a humanoid object using a depth sensor, and then establishing a region of interest for recognition by a 2D pedestrian recognition device. The present invention uses the Lidar or a combination of various depth sensors and cameras, and at the same time, two sensors are used for detection and identification, and after matching and aggregation into a new candidate list, the relative sensor performs the secondary identify.

In one embodiment, a method for identifying a pedestrian of the present invention, comprising: capturing an original image, detecting a pedestrian in the original image, and obtaining a 2D (two-dimensional) pedestrian feature image from the original image; obtaining a 3D (three-dimensional) data, and performing a 3D identification process for the 3D data to obtain a 3D pedestrian feature map with the pedestrian feature; projecting the 3D pedestrian feature map onto a 2D pedestrian feature plane image; and matching the 2D pedestrian feature image and the 2D pedestrian feature plane image to obtain a matching image; wherein the original image and the 3D data are simultaneity obtained.

In the embodiment, when the 2D pedestrian feature image is not obtained, the obtained original image is processed for a second 3D identification to obtain a first interest area, and the first interest area is identified to obtain the 2D pedestrian feature image.

In the embodiment, the 3D pedestrian feature map is not obtained, the obtained 3D data is processed for a second detection to obtain a second interest area, and the second interest area is identified to obtain the 3D pedestrian feature map.

In the embodiment, the pedestrian in the original image is detected by a depth learning technology, and the 3D data is processed for a second detection. Wherein the deep learning technology may be a deep neural network technology or one of the machine learning technologies.

In one embodiment, when the 3D pedestrian feature map is projected to the 2D pedestrian feature plane image, detection points are projected onto a multi-layer grid map, each object in the multi-layer grid map is identified as the highest and lowest points of the each object for adjustment, the object is cut from the multi-layer grid map to determine which one grid belong to the object through continuous grid values, and however, if the continuous grids have different heights from each other, the object will be cut and adjusted if the lowest point of the grid around the adjacent continuous grid is higher than the highest point of the continuous grid. In other word, in a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range

In one embodiment, a system for identifying a pedestrian of the present invention, comprising: an image capturing device, capturing an original image, detecting a pedestrian in the original image, and obtaining a 2D (two-dimensional) pedestrian feature image from the original image; a depth sensing device, obtaining a 3D (three-dimensional) information, and performing a 3D identification process for the 3D information to obtain a 3D pedestrian feature map with the pedestrian feature; and a matching device, matching the 2D pedestrian feature image and the 2D pedestrian feature plane image to obtain a matching image; wherein the image capturing device and the depth sensing device respectively and simultaneity obtain the original image and the 3D data.

In the embodiment, the image capturing device does not obtain the 2D pedestrian feature image, the obtained original image is transmitted to the depth sensing device to perform the second identification process to obtain a first interest area, and the depth sensing device identifies the first interest area to obtain the 2D pedestrian feature image.

In the embodiment, when the depth sensing device does not obtain the 3D pedestrian feature image, the 3D data is transmitted to the image capturing device for a second detection to obtain a second interest area, and the image capturing device identifies the second interest area to obtain the 3D pedestrian feature map.

In the embodiment, the pedestrian in the original image is detected by a depth learning technology, and the 3D data is processed for a second detection. Wherein the deep learning technology may be a deep neural network technology or one of the machine learning technologies.

In the embodiment, when the match device projects the 3D pedestrian feature map to the 2D pedestrian plane image, the 3D pedestrian feature map is changed from a spherical coordinate to a Cartesian coordinate. Additionally, when the 3D pedestrian feature map is projected to the 2D pedestrian feature plane image, detection points are projected onto a multi-layer grid map, each object in the multi-layer grid map is identified as the highest and lowest points of the each object for adjustment, the object is cut from the multi-layer grid map to determine which one grid belong to the object through continuous grid values, and however, if the continuous grids have different heights from each other, the object will be cut and adjusted if the lowest point of the grid around the adjacent continuous grid is higher than the highest point of the continuous grid. In other word, in a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range.

Compared with the conventional technology, the present invention utilizes a depth sensor with a Lidar technology and an image capture device to simultaneously detect and identify the environment, and respectively perform 2D and 3D pedestrian recognition on the image and depth. In 3D pedestrian recognition, point clouds are projected onto a multi-layer grid map, and then pedestrian recognition is performed. Because the present invention makes the second 3D and 2D pedestrian identification, and performs the second verification on the first identification, each pedestrian is classified and screened by two-dimensional and three-dimensional. Pedestrians misjudge or miss judgments, pedestrian overlap is not easy to detect, and two objects connected to the depth interception device are not easy to separate.

### BRIEF DESCRIPTION OF THE DRAWINGS

FIG. 1 shows a block diagram of a system for identifying a pedestrian according to one embodiment of the present invention;

FIG. 2 shows a flow char of 3D humanoid object extraction;

FIG. 3 shows a flow chart of the method for identifying a pedestrian according to one embodiment of the present invention.

### DETAILED DESCRIPTION

In the drawings, the thicknesses of layers, films, panels, regions, etc. are exaggerated for clarity. Throughout the description, the same reference numerals denote the same elements. It will be understood that when an element such as a layer, film, region, or substrate is referred to as being “on” or “connected to” another element, it can be directly on or connected to the other element, or Intermediate elements may also be present. In contrast, when an element is referred to as being “directly on” or “directly connected to” another element, there are no intervening elements present. As used herein, “connected” may refer to a physical and/or electrical connection. However, the electrical connection is such that there are other elements between the two elements.

It should be understood that, although the terms “first” and “second” etc. may be used herein to describe various elements, components, regions, layers and/or sections, these elements, components, regions, and/or sections should not be affected Limitations of these terms. These terms are only used to distinguish one element, component, region, layer or section from another element, component, region, layer or section. Thus, a “first element,” “component,” “region,” “layer,” or “portion” discussed below may be termed a second element, component, region, layer, or section without departing from the teachings herein.

The terminology used herein is for the purpose of describing particular embodiments only and is not limiting. As used herein, the singular forms “a”, “an” and “the” are intended to include the plural forms including “at least one” unless the content clearly indicates otherwise. “Or” means “and/or”. As used herein, the term “and/or” includes any and all combinations of one or more of the associated listed items. It should also be understood that when used in this specification, the terms “including” and/or “including” designate the stated features, regions, wholes, steps, operations, presence of elements and/or components, but do not exclude one or more the presence or addition of other features, areas as a whole, steps, operations, elements, components, and/or combinations thereof.

In addition, relative terms such as “lower” or “bottom” and “upper” or “top” may be used herein to describe the relationship of one element to another element, as shown. It should be understood that relative terms are intended to include different orientations of the device in addition to the orientation shown in the figures. For example, if the device in one of the figures is turned over, elements described as being on the “lower” side of other elements would then be oriented on “upper” sides of the other elements. Thus, the exemplary term “down” may include orientations of “down” and “up”, depending on the particular orientation of the drawings. Similarly, if the device in one of the figures is turned over, elements described as “below” or “beneath” other elements would then be oriented “above” the other elements. Thus, the exemplary terms “below” or “below” may include orientations above and below.

As used herein, “about” or “substantially” includes the stated value and an average value within an acceptable deviation range of a particular value determined by one of ordinary skill in the art, taking into account the measurement in question and measurement-related errors. A specific number (i.e., a limitation of the measurement system). For example, “about” may mean within one or more standard deviations of the stated value, or within ±30%, ±20%, ±10%, ±5%. Furthermore, as used herein, “about” or “substantially” A more acceptable range of deviations or standard deviations can be selected based on optical properties, etching properties, or other properties, and all properties can be applied without one standard deviation.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overlay formal sense unless expressly so defined herein.

The exemplary embodiment is described below with reference of a cross-sectional view of a schematic diagram of an idealized embodiment. Therefore, a shape change of the figure serving as a result of manufacturing techniques and/or tolerances may be expected. Therefore, the embodiment of the disclosure should not be construed as limited to a particular shape of a region as shown herein, but includes a shape deviation caused by manufacturing tolerance. For example, a shown or described flat area may generally have rough and/or non-linear features. Moreover, a shown acute angle may be round. Therefore, a region shown in the figure is essentially schematic, and a shape thereof is not intended to show an accurate shape of the region, and is not intended to limit a range of the claims of the disclosure.

FIG. 1 shows a block diagram of a system for identifying a pedestrian according to one embodiment of the present invention. The system for identifying the pedestrian comprises: an image capturing device 11, a depth sensing device 12 and the matching device 13. The image capturing device 11 captures an original image, detects a pedestrian in the original image, and obtains a 2D (two-dimensional) pedestrian feature image from the original image; the depth sensing device 12 obtains a 3D (three-dimensional) information, and performs a 3D identification process for the 3D information to obtain a 3D pedestrian feature map with the pedestrian feature; and the matching device 13 matches the 2D pedestrian feature image with the 2D pedestrian feature plane image to obtain a matching image. Specifically, the image capturing device 11 and the depth sensing device 12 respectively and simultaneity obtain the original image and the 3D data.

In the embodiment, when the image capturing device 11 does not obtain the 2D pedestrian feature image, the obtained original image is transmitted to the depth sensing device 12 for a second 3D identification process to obtain the first interest area. The depth sensing device 12 identifies the first interest area to obtain the 2D pedestrian feature image. In the embodiment, when the depth sensing device 12 does not obtain the 3D pedestrian feature image, the 3D data is transmitted to the image capturing device 11 for a second detection to obtain a second interest area. The image capturing device 11 identifies the second interest area so as to determine whether the object is the pedestrian. Specifically, the first and second interest areas can be determined by threshold value, for example, when the image capturing device 11 first obtains the pedestrian feature image, the pedestrian feature image is obtained according to the default threshold of 0.85, and when the depth sensing device 12 does not obtain the 3D pedestrian feature image and the image capturing device 11 obtains the 2D pedestrian feature image, the obtained original image is transmitted to the depth sensing device 12 for a second 3D identification process and the pedestrian feature slot or frame to form the first interest area. Next, the depth sensing device 12 will be the first area of interest according to the default threshold 0.6 to obtain two-dimensional pedestrian feature image. In addition, the image capture device 11 uses deep learning technology to detect pedestrians in the original image and detects the 3D data for the second time. The above-mentioned depth sensing device 12 may be LiDAR. In this embodiment, the depth sensing device 12 may be a 16-channel LiDAR, but it is not limited thereto.

In the embodiment, when the match device 13 projects the 3D pedestrian feature map to the 2D pedestrian plane image, the 3D pedestrian feature map is changed from a spherical coordinate to a Cartesian coordinate. When the 3D pedestrian feature map is projected to the 2D pedestrian feature plane image by the matching device 13, detection points are projected onto a multi-layer grid map, each object in the multi-layer grid map is identified as the highest and lowest points of the each object for adjustment, the object is cut from the multilayer grid map to determine which one grid belong to the object through continuous grid values, and however, if the continuous grids have different heights from each other, the object will be cut and adjusted if the lowest point of the grid around the adjacent continuous grid is higher than the highest point of the continuous grid. In a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range.

The matching device 13 is transformed from 3D data into 3D pedestrian feature maps and can be further subdivided into two main steps: 3D human-like object extraction and 3D pedestrian recognition.

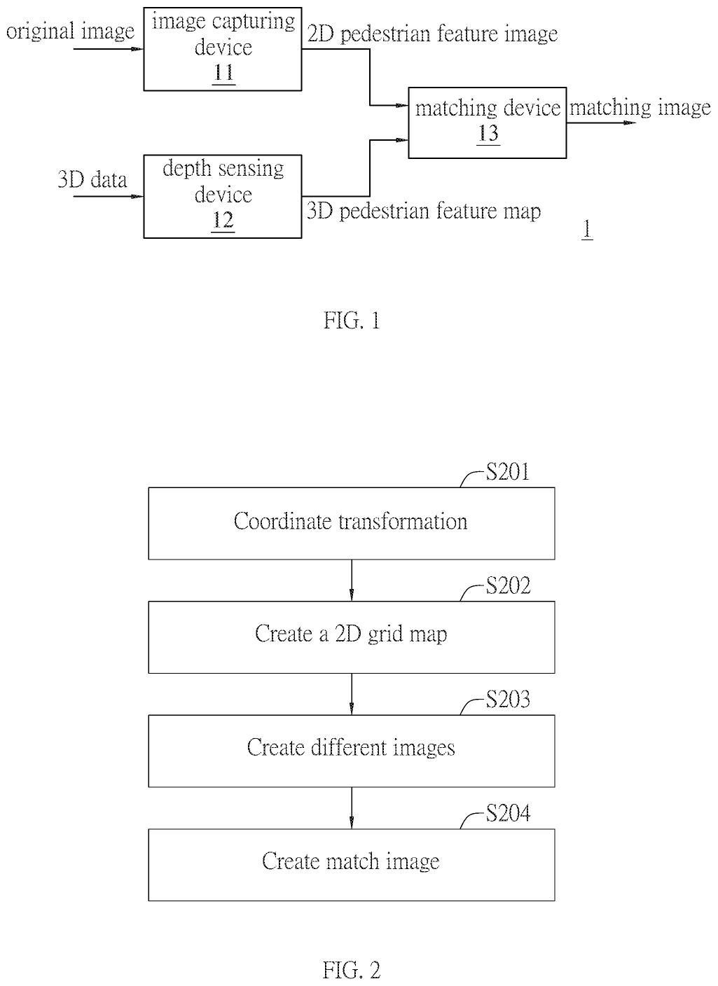

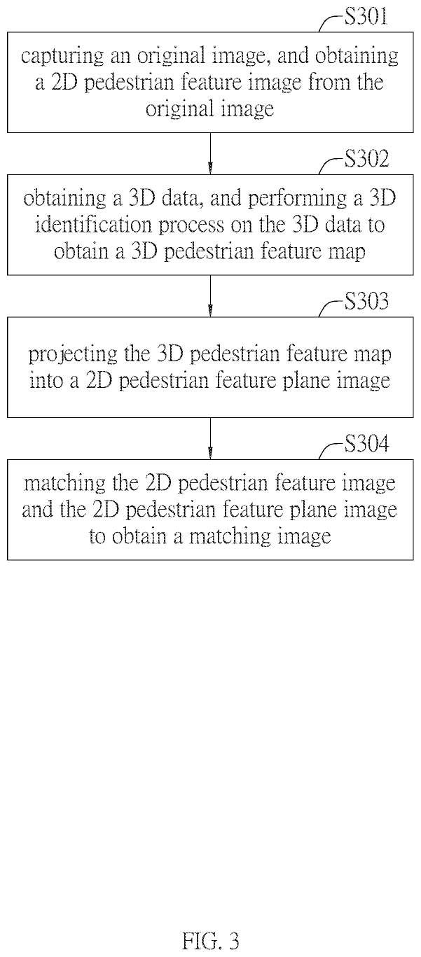

FIG. 2 shows a flow char of 3D humanoid object extraction. As shown in FIG. 2, the 3D pedestrian feature image is firstly converted from spherical coordinates to Cartesian coordinate (XYZ coordinates) (the step of S201), detecting point clouds of the depth sensing device 12 are used to build a 2D grid map (BinMap) of N-layers (the step of S202), where the number of N is, the point detected by the each laser must be projected onto each grid map, and all size of the grid map, the size of the grid and height of the grid are adjustable parameters, and thereby N grid maps are built by the adjustable grid maps, the adjustable grids and the adjustable height of grids. In the embodiment, the size of grid is 10*10 squarer centimeter, and the height of grid is 10 cm, the map size is 30 meters around the device, but not to the limit.

N grid maps can be used to distinguish between obstacles of different heights, and when a grid at the same location has a breakpoint in different grid maps (no value), this means that this position and height of the breakpoint are perbed by the laser, and the objects at both ends are not the same object, and the breakpoint is defined as the passage of two objects of different heights at this position with more than two mines passing apart. The above method can distinguish or sift out objects below different heights in a grid to create different images (the step of S203), and labeling the connected component labeling (CCL), integrate corresponding grids in the same object to build the matching map (BlobMap) (the step of S204), and outputs and lists corresponding point cloud of each humanoid object to offer the 3D pedestrian identification classification.

In the embodiment, the 3D identification process uses the 3D support vector machine (SVM) to identify whether the object is a pedestrian, and then outputs the classification result of the all objects, and also all humanoid object are projected onto the image plane, and establish the area of interest of all kinds of human objects.

In the embodiment, the fast area convolutional neural network is used to detect and identify the 2D image to output the result of pedestrian detection of images.

In the embodiment, the matching device 13 integrates the pedestrian identification result of the image capturing device 11 and the depth sensing device 12, and inputs the area of interest (depth sensing device terminal) of a humanoid object and a pedestrian detection result (image capturing device terminal), comparing the both of interest areas whether is overlapped, the matchmaking method is to check whether the bottom boundary of the two regions of interest is less than a threshold (bottom difference), in this determination, 50 pixels is set. If the above condition is yes, checking whether the width of the two regions of interest is less than a threshold (Width Difference), in this determination, 50 pixel is set. If the above condition is determined as the overlapping, the result of 2D and 3D pedestrian identification is merged. The remaining non-overlapping areas from the two interests are sent to the secondary pedestrian recognition separately, and if it is the area of interest of the humanoid object from the depth sensor, and send it to one or two 2D pedestrian recognition; if it is the area of interest of the pedestrian coming from the image capture device, collect the detection points of the depth sensor in each area of interest and send it to the primary and secondary 3D pedestrian recognition device to identify. In this embodiment, the thresholds with different bottoms and different widths can be adjusted according to different image resolutions, without being limited thereto.

The process of the second 3D pedestrian identification is equal with the process of the 3D pedestrian identification device, and similarly, the second 2D pedestrian identification process is equal with the process of the 2D pedestrian identification device. Finally, to integrate the 2D and 3D recognition results with the object distance, aggregate the results from the 2D pedestrian recognition and the 2D 3D pedestrian output, and output the 2D and 3D recognition results of each pedestrian in the image and the match with the object distance image.

FIG. 3 shows a flow chart of a method for identifying a pedestrian according to one embodiment of the present invention. As shown in FIG. 3, the method for identifying the pedestrian comprises: capturing an original image, detecting a pedestrian in the original image, and obtaining a 2D (two-dimensional) pedestrian feature image from the original image (the step of S301); obtaining a 3D (three-dimensional) data, and performing a 3D identification process for the 3D data to obtain a 3D pedestrian feature map with the pedestrian feature (the step of S302). Then, projecting the 3D pedestrian feature map onto a 2D pedestrian feature plane image (S303); and matching the 2D pedestrian feature image and the 2D pedestrian feature plane image to obtain a matching image (the step of S304). Specifically, the original image and the 3D data are simultaneity obtained.

In the embodiment, the image capturing device does not obtain the 2D pedestrian feature image, the obtained original image is transmitted to the depth sensing device to perform the second identification process to obtain a first interest area.

In the embodiment, when the 3D pedestrian map is not obtained, the 3D data is subject to the second detected to obtain a second interest area, and the second interest area is subjected to an identification process to obtain the 3D pedestrian feature map.

In the embodiment, the machine learning technology is used to detect pedestrians in the original image and to detect the 3D data for the second time. In the embodiment, when the 3D pedestrian feature map is projected to the 2D pedestrian feature plane image, detection points are projected onto a multi-layer grid map, each object in the multi-layer grid map is identified as the highest and lowest points of the each object for adjustment, the object is cut from the multi-layer grid map to determine which one grid belong to the object through continuous grid values, and however, if the continuous grids have different heights from each other, the object will be cut and adjusted if the lowest point of the grid around the adjacent continuous grid is higher than the highest point of the continuous grid. In other word, in a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range.

Most existing technologies only believe that one sensor can detect all conditions, ignoring the value of sensor fusion. Usually in the part of the camera, the obscured objects and the shadows are dim, the recognition rate is weak, and when the light reaches the objects, it cannot be properly separated. Therefore, the present invention integrates two sensors to simultaneously detect and identify the environment, so as to overcome the problems of pedestrian misjudgment or omission in the prior art, the difficulty of detecting pedestrian overlap, and the difficulty of separating two objects connected by the depth interception device, and improve detection the measurement rate.

In addition, in the prior art, in the steps of projecting onto a grid map to distinguish objects, the previous method is to directly project 3D information onto a 2D grid map, resulting in problems that objects at different heights overlap and cannot be separated, and if projected on a 3D grid map, it will cause too much memory waste. Therefore, the present invention uses a multi-layer grid map to establish a two-dimensional grid map exclusively for each laser of the Lidar. This N-layer grid map records the heights of points detected by different lasers or different lasers, and retains the height information can distinguish objects at different heights, and the number of layers of the multi-layer grid map is the same as the number of laser roots. Compared to the three-dimensional grid map, many problems of wasting space without detecting points at different heights are eliminated.

The present invention is described in the foregoing related embodiments, but the foregoing embodiments are merely examples for implementing the present invention. It needs be noted that the disclosed embodiments do not limit scope of the present invention. On the contrary, all modifications and equivalents included in a spirit and the scope of the present invention are included in the scope of the present invention.

What is claimed is:

1. A method for identifying a pedestrian, comprising:
capturing an original image, detecting a pedestrian in the original image, and obtaining a 2D (two-dimensional) pedestrian feature image from the original image;
obtaining a 3D (three-dimensional) data, and performing a 3D identification process for the 3D data to obtain a 3D pedestrian feature map with the pedestrian feature;
projecting the 3D pedestrian feature map onto a 2D pedestrian feature plane image; and
matching the 2D pedestrian feature image and the 2D pedestrian feature plane image to obtain a matching image;
wherein the original image and the 3D data are simultaneity obtained.

2. The method according to claim 1, wherein when the 2D pedestrian feature image is not obtained, the obtained original image is processed for a second 3D identification to obtain a first interest area.

3. The method according to claim 2, wherein the first interest area is identified to obtain the 2D pedestrian feature image.

4. The method according to claim 1, wherein the 3D pedestrian feature map is not obtained, the obtained 3D data is processed for a second detection to obtain a second interest area.

5. The method according to claim 4, wherein the second interest area is identified to obtain the 3D pedestrian feature map.

6. The method according to claim 1, wherein the pedestrian in the original image is detected by a depth learning technology, and the 3D data is processed for a second detection.

7. The method according to claim 1, wherein when the 3D pedestrian feature map is projected to the 2D pedestrian plane image, the 3D pedestrian feature map is changed from a spherical coordinate to a Cartesian coordinate.

8. The method according to claim 7, wherein when the 3D pedestrian feature map is projected to the 2D pedestrian feature plane image, detection points are projected onto a multi-layer grid map, each object in the multi-layer grid map is identified as the highest and lowest points of the each object for adjustment, the object is cut from the multi-layer grid map to determine which one grid belong to the object through continuous grid values, and however, if the continuous grids have different heights from each other, the object will be cut and adjusted if the lowest point of the grid around the adjacent continuous grid is higher than the highest point of the continuous grid.

9. The method according to claim 8, wherein in a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range

10. A system for identifying a pedestrian, comprising:
an image capturing device, capturing an original image, detecting a pedestrian in the original image, and obtaining a 2D (two-dimensional) pedestrian feature image from the original image;
a depth sensing device, obtaining a 3D (three-dimensional) information, and performing a 3D identification process for the 3D information to obtain a 3D pedestrian feature map with the pedestrian feature; and
a matching device, matching the 2D pedestrian feature image and the 2D pedestrian feature plane image to obtain a matching image;
wherein the image capturing device and the depth sensing device respectively and simultaneity obtain the original image and the 3D data.

11. The system according to claim 10, wherein the image capturing device does not obtain the 2D pedestrian feature image, the obtained original image is transmitted to the depth sensing device to perform the second identification process to obtain a first interest area.

12. The system according to claim 11, wherein the depth sensing device identifies the first interest area to obtain the 2D pedestrian feature image.

13. The system according to claim 10, wherein when the depth sensing device does not obtain the 3D pedestrian feature image, the 3D data is transmitted to the image capturing device for a second detection to obtain a second interest area.

14. The system according to claim 13, wherein the image capturing device identifies the second interest area to obtain the 3D pedestrian feature map.

15. The system according to claim 10, wherein the image capturing device detects the pedestrian in the original image by a depth learn technology.

16. The system according to claim 10, wherein when the match device projects the 3D pedestrian feature map to the 2D pedestrian plane image, the 3D pedestrian feature map is changed from a spherical coordinate to a Cartesian coordinate.

17. The system according to claim 16, wherein when the 3D pedestrian feature map is projected to the 2D pedestrian feature plane image, detection points are projected onto a multi-layer grid map, each object in the multi-layer grid map is identified as the highest and lowest points of the each object for adjustment, the object is cut from the multi-layer grid map to determine which one grid belong to the object through continuous grid values, and however, if the continuous grids have different heights from each other, the object will be cut and adjusted if the lowest point of the grid around the adjacent continuous grid is higher than the highest point of the continuous grid.

18. The system according to claim 17, wherein in a multi-layer grid map, whether the values in the continuous grid are all 1 (meaning there is a value) to determine whether an object under test, and if the highest point of some of the continuous grids in the continuous grid in the object to be tested is smaller than the lowest point of the surrounding grid, the object grid will be adjusted for cutting, and the object to be tested will be post-processed to select the object to be tested that matches the pedestrian range.
